(19) United States
(12) Patent Application Publication
(10) Pub. No.: US 2015/0189375 A1
(43) Pub. Date: Jul. 2, 2015

(54) SYSTEMS AND METHODS FOR PRESENTING INFORMATION TO GROUPS OF USERS USING USER OPTICAL DEVICES

(71) Applicant: United Video Properties, Inc., Santa Clara, CA (US)

(72) Inventors: Walter R. Klappert, Los Angeles, CA (US); Brian Craig Peterson, Barrington, IL (US); William J. Korbecki, Crystal Lake, IL (US); Vanessa Wickenkamp, Elmhurst, IL (US); Michael R. Nichols, La Canada Flintridge, CA (US); Melissa Bradley, Mt. Prospect, IL (US)

(73) Assignee: United Video Properties, Inc., Santa Clara, CA (US)

(21) Appl. No.: 14/143,899

(22) Filed: Dec. 30, 2013

(51) Int. Cl. H04N 21/436; H04N 21/485; H04N 21/45; H04N 21/41

(52) U.S. Cl. CPC H04N 21/43615; H04N 21/4122; H04N 21/4126; H04N 21/485; H04N 21/4532

(57) ABSTRACT

Methods and systems are disclosed herein for presenting information to groups of users using user optical devices that enable each user to view and share media content in a collaborative manner. For example, users using linked user optical devices may perceive a media playlist on a particular wall. The media playlist may then be modified (e.g., media assets may be added and/or removed) based on any of the users contacting the particular wall.

### BACKGROUND

Users are increasingly consuming content on smaller, more mobile devices. For example, the use of smartphones, tablets, etc. are increasingly common. Moreover, users frequently use their mobile devices to share content amongst each other. However, while content may be shared and viewed on multiple devices, the small screens and limited user input interface types available on such devices often impede collaborations by multiple users.

### SUMMARY

Accordingly, methods and systems are disclosed herein for presenting information to groups of users using user optical devices that enable each of the users to view and share media content in a collaborative manner. Specifically, the media guidance application links multiple user optical devices (e.g., computer glasses) together such that each of the user optical devices presents (e.g., on the lenses of the computer glasses) the same virtual presentation of media content when directed at a particular location. The media content may further be perceived by a user as fixed to real world objects and modified based on intuitive user interactions at the real world objects. For example, each user of a linked user optical device may perceive a media playlist on a particular wall. The media playlist may then be modified (e.g., media assets may be added and/or removed) based on any of the users contacting the particular wall.

In some aspects, the media guidance application receives a first user input to present content using a first user optical device, associated with a first user, when the first user optical device is directed at a first position. The media guidance application then receives a second user input identifying a second user and determines a second user optical device associated with the second user. The media guidance application then transmits instructions to the second user optical device to present the content when the second user optical device is directed at the first position.

In some embodiments, the media guidance application presents the content on the first user optical device when the first user optical device is directed at the first position. For example, the media guidance application may generate a virtual presentation of the content such that the content appears to the user as being fixed to a particular real world object at the position (e.g., a portion of a wall). Specifically, the media guidance application may generate a display of the content on the lenses of computer glasses such that a user viewing the object through the computer glasses sees the content overlaid on the object.

The media guidance application may also not present the content on the first user optical device when the first user optical device is directed at a second position. For example, the media guidance application may determine whether or not the first user optical device is directed at the object at the position (e.g., corresponding to a user looking at the portion of the wall). If the first user optical device is no longer directed at the object at the position (e.g., corresponding to a user looking at the ceiling), the media guidance application will not generate a virtual presentation of the content (e.g., the content will not appear to move, from the viewpoint of the user, relative to the portion of the wall).

In some embodiments, the media guidance application may receive a third user input, at the first user optical device, modifying the content and instruct the second user optical device to present the modified content when directed at the first position. For example, the media guidance application may allow users to modify, or otherwise interact with, the virtual presentation of the content. For example, the content may include a media playlist, in which users may add or remove media assets. To do so, the media guidance application (e.g., implemented on a first user optical device) may detect that a user (e.g., associated with the first user optical device) is interacting with the object to which the content is fixed. Furthermore, the media guidance application may determine that the interactions (e.g., touches, swipes, etc.) correspond to user requests to modify the content. Based on these interactions, the media guidance application modifies the content (e.g., as perceived by the user) and instructs other user optical devices (e.g., associated with other users) to simultaneously modify the content (e.g., as perceived by the other users).

In some embodiments, only user optical devices (e.g., which may be configured as headwear) that are determined to be associated with an identified user and also receive the instructions to present the content will generate a virtual presentation of the content. For example, the media guidance application may link a plurality of user optical devices so that only users associated with the linked user optical devices may perceive the content. In some embodiments, the media guidance application may receive user inputs identifying each user that should be able to perceive the content. In some embodiments, the media guidance application may automatically identify the users based on relationships of the users. For example, a first user may host the presentation of the content and automatically invite other users that share a geographic, demographic, familial, or social network relationship with the first user to have their respective user optical devices also present the content.

In some embodiments, the media guidance application may determine whether the second user is within a viewing area associated with the first position and instruct the second user optical device to not present the content in response to determining the second user is not within a viewing area associated with the first position. For example, the media guidance application may only transmit instructions to present content if a user is determined to be within a viewing area. For example, the media guidance application may establish a proximity to the first position that is considered a viewing area, and instructions to view the content may only be transmitted to user optical devices determined to be within that proximity.

It should be noted, the systems and/or methods described above may be combined with, applied to, or used in accordance with, other systems, methods and/or apparatuses discussed both above and below.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a media guidance display that may be presented in accordance with some embodiments of the disclosure;

FIG. 2 shows another illustrative example of a media guidance display that may be presented in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5A is an illustrative example of a viewing area for use in presenting content using user optical devices in accordance with some embodiments of the disclosure;

FIG. 5B is another illustrative example of a viewing area for use in presenting content using user optical devices in accordance with some embodiments of the disclosure;

FIG. 6 is a flowchart of illustrative steps for presenting content to multiple users in accordance with some embodiments of the disclosure;

FIG. 7 is a flowchart of illustrative steps for presenting content subject to user modifications in accordance with some embodiments of the disclosure; and

FIG. 8 is an illustrative example of a component used to determine the gaze point of a user in accordance with some embodiments of the disclosure.

### DETAILED DESCRIPTION OF THE DRAWINGS

Methods and systems are disclosed herein for presenting information to groups of users using user optical devices that enable each user to view and share media content in a collaborative manner. Specifically, the media guidance application links multiple user optical devices together such that each of the user optical devices presents the same virtual presentation of content when directed at a particular location or object.

As used herein, “a media guidance application,” refers to an application that provides a form of media guidance through an interface that allows users to view media content. Interactive media guidance applications may take various forms depending on the content. One typical type of media guidance application is an interactive television program guide. In some embodiments, the media guidance application may be provided as an on-line application (i.e., provided on a website), or as a stand-alone application on a server, user device, etc. Various devices and platforms that may implement the media guidance application are described in more detail below. In some embodiments, the media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media card, register memory, processor caches, Random Access Memory (“RAM”), etc.

Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

In some embodiments, the media guidance application may also present media guidance data. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

In some embodiments, content may be presented as virtual. Virtual content refers to content that does not physically exist, or does not have a physical relationship to an object that physically exists, but is made to appear to be physically existing, or made to appear to have a physical relationship to an object that physically exists, by the media guidance application. For example, the media guidance application may present content that appears to be a physically existing object (e.g., a virtual television screen) overlaid on an actual physically existing object (e.g., a real world wall, table, floor, ceiling, billboard, etc.). Furthermore, the media guidance application may present content that appears to a user to be fixed to the physically existing object. For example, the media guidance application may present a virtual display screen such that the display screen appears to be incorporated into a physically existing wall.

In some embodiments, content is given the appearance of physically existing (i.e., being virtual) through the use of user optical devices. As referred to herein, “an user optical device” is an optical head-mounted display through which a user may perceive both physically existing content and content generated by the media guidance application. For example, an user optical device may be fashioned as traditional headwear (e.g., glasses, visors, goggles, masks, etc.) that includes heads-up display features. Each user optical device features a heads-up display (i.e., a transparent display that presents data without requiring users to look away from their usual viewpoints) that allows a user to perceive both physically existing objects (e.g., real world objects) and virtual objects (e.g., objects generated by the media guidance application that appear to be physically existing). Typically, the heads-up display is incorporated into the lens (or a corresponding feature) of the user optical device such that a user may perceive virtual content anywhere within the field of vision of the user (and virtual content may be overlaid on any object within the field of vision of the user).

In some embodiments, user optical devices may be referred to as user equipment devices. As referred to herein, the phrase “user equipment device,” “user equipment,” “user device,” “electronic device,” “electronic equipment,” “media equipment device,” or “media device” should be understood to mean any device, including user optical devices, for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same.

In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

In some embodiments, a camera through which a user views physically existing objects may also function as an user optical device, if the camera is capable of receiving virtual content generated by the media guidance application while the user is viewing physically existing objects. For example, a user looking through the display screen of a smartphone, which is displaying real world objects captured by a camera associated with the smartphone, may also see virtual content present my a media guidance application. In such cases, the smartphone may act as an user optical device.

In some embodiments, the media guidance application may also present content through the use of a camera and/or projector. For example, a projector may cause content to appear at a particular location (with or without the use of a user optical device). The media guidance application may then determine whether or not the content is modified (as discussed below) in response to detecting user interactions at the location.

In some embodiments, the media guidance application may only present the virtual content when an user optical device is directed at a position associated with the content. For example, if content is associated with a particular position (or a particular object at the position), the content (as perceived by the user) will not move if the user looks away from the position. Consequently, if a user looks away from a real world object to which virtual content is fixed, the user will not perceive the virtual content. However, if the user looks back at the real world object, the user will once again perceive the virtual content.

By only presenting the virtual content when an user optical device is directed at a position associated with the content, the media guidance application preserves the perception of the user that the content is fixed to a real world object. Furthermore, by maintaining the location of the content at a position (e.g., as opposed to always presenting the content in the heads-up display of an user optical device), the media guidance application provides a single real world reference point at which multiple users may commonly perceive the content and interact with the content. For example, as the virtual presentation is fixed to a single real world object, multiple users may gravitate to the real world object to collaboratively view, discuss, and/or modify the virtual content. In contrast, if the virtual presentation was not fixed to a real world object, the users would have no motivation to come together.

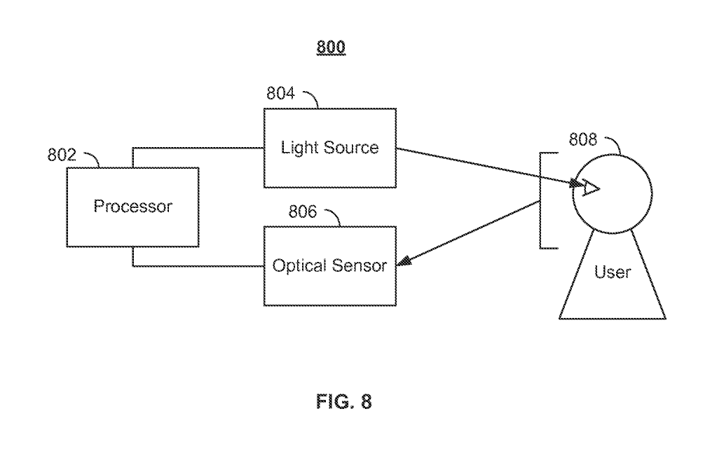

In some embodiments, the media guidance application may also detect whether or not a user is focusing on a position associated with the content. For example, the media guidance application may generate a presentation of the content only in response to determining that a user is focusing on the position associated with the content. For example, as discussed below in relation to FIG. 8, the media guidance application may include an eye contact detection component, which determines or receives a location upon which one or both of a user's eyes are focused. Based on whether or not the user's eyes are focused on the position associated with the content, the media guidance application may generate a presentation of the content.

In some embodiments, the media guidance application may determine whether or not particular brain activity or blink patterns are detected. In response to determining that a threshold frequency of alpha bands (e.g., a particular brain activity) or three consecutive eye blinks (e.g., a blink pattern) are detected, the media guidance application may generate a presentation of virtual content. The detection of brain activity and blink patterns is discussed in greater detail in Klappert et al., U.S. patent application Ser. No. 14/038,158, filed Sep. 26, 2013 which is hereby incorporated by reference herein in its entirety.

In some embodiments, the media guidance application may modify the presented content in response to user interactions. For example, if the media guidance application presents content that is fixed to a particular real world object, the media guidance application may monitor the actions of a user relative to the real world object. If the user contacts the real world object and/or performs other actions within the vicinity of the real world object, the media guidance application may determine whether or not the contact and/or actions cause a corresponding change to the present content. If so, the media guidance application may update the content based on the modifications associated with the contact and/or actions.

For example, a user of an user optical device may perceive a television program as appearing on a virtual display screen on a wall. The media guidance application may further determine that the user is making contact with the wall (e.g., touching, swiping, etc.). Based on this user interaction (e.g., associated with changing a channel), the media guidance application may modify the content in ways corresponding to the contact the user made with the wall (e.g., by changing the channel). In another example, the media guidance application may present a media playlist that appears to be fixed to a physically existing table. The media playlist may be modified (e.g., media assets may be added and/or removed) based on a user contacting the table with suitable motions or gestures.

In some embodiments, the media guidance application may modify the presented content in response to user interactions received on another user device. For example, inputs received via a personal computer, tablet, smartphone, etc. may cause the media guidance application to modify the content presented. For example, the media guidance application may receive a modification to a virtual media playlist in response to a user “throwing” (e.g., executing a swiping motion on a touch-screen display in the direction of the virtual media playlist).

In some embodiments, only user optical devices (e.g., which may be configured as headwear) that are determined to be associated with an identified user and subsequently receive the instructions to present the content will generate a virtual presentation of the content. For example, in addition to requiring an user optical device for perceiving the content, the user optical device may need to receive instructions to present the content from a host device (e.g., another user optical device). After receiving the instructions, the media guidance application may link the user optical devices so both user optical devices present the same content simultaneously. Furthermore, the one or more media guidance applications implemented on the linked user optical user devices may transmit instructions (e.g., indicating the modification, if any, in the content) back and forth between linked user optical devices. For example, the linked optical user devices may then presented the modified content concurrently. In contrast, other users without the optical user devices and/or without linked optical user devices will not perceive any content presented (modified or otherwise).

In some embodiments, the media guidance application may receive user inputs identifying each user (and/or each user optical device) that should be able to perceive the content. In some embodiments, the media guidance application may automatically identify the users based on the relationships of the user. For example, a first user may host the presentation of the content and automatically invite other users that share a geographic, demographic, familial, or social network relationship with the first user to have their respective user optical devices linked.

In some embodiments, the media guidance application may retrieve a list of other users that are associated with the user based on one or more criteria. For example, the media guidance application may retrieve a list of friends (e.g., a social network buddy list), contacts (e.g., retrieved from a phone/text message/e-mail account associated with the user), and/or other listings featuring other users associated with the user from a server or other device to identify potential users (and/or user optical device that should be linked.

As used herein, a “social network,” refers to a platform that facilitates networking, typically via a computer, and/or social relations among people who, for example, share interests, activities, backgrounds, and/or real-life connections. For example, the server may be a social media server owned/operated/used by social media provider that makes (e.g., status updates, microblog posts, images, graphic messages, etc.) of a first event associated with a first user accessible to a second user that is within the same social network as the first user. As used herein, a “social media server” refers to a server that facilitates a social network.

In some embodiments, identifying a user and an user optical device associated with the user may be synonymous. For example, a media guidance application may retrieve a listing (e.g., from a user profile associated with one or more users) of one or more devices associated with the one or more identified users. Furthermore, in some embodiments, when a user operates an user optical device, the user optical device may transmit identification information to other user optical devices identifying the user that is currently operating the user optical device. The media guidance application may use any receive/retrieve information about a user relationships to user optical devices to identify an user optical device associated with a user.

In some embodiments, the media guidance application may transmit a message or invitation to other users (and/or other user optical devices) querying the user as to whether or not they care to perceive content hosted by the first user. In response to the message or invitation, the media guidance application may receive an answer from a media guidance application implemented on another user optical device as to whether or not that user wishes to perceive the content. If so, the media guidance applications establish a link in order to simultaneously present the same content.

In some embodiments, the media guidance application may determine whether the second user is within a viewing area associated with the first position and not instruct the second user optical device to present the content when the second user optical device is directed at the first position in response to determining the second user is not within a viewing area associated with the first position. For example, the media guidance application may establish a proximity to the first position that is considered a viewing area, and instructions to view the content may only be transmitted to user optical devices determined to be within that proximity.

For example, in some embodiments, virtual content may be presented such that a grouped of users at a single location may collaborate to modify the virtual presentation. If a user is not physically present in a location of the other users, the user may not wish to be presented with the virtual content. Furthermore, a user may not wish to perceive all virtual content that is currently being presented anywhere. For example, while virtual content may be presented at the same direction that a user is looking, the virtual presentation may be associated with a real world object that is kilometers away. Accordingly, the user may not wish to have the virtual content presented on his/her user optical device.

In some embodiments, to present virtual content such that it is perceived by a user as being fixed to a real world object, the media guidance application may determine the appropriate location on the lenses of an optical user device to present the virtual content. Generating a display of content on a head-mounted eye-piece for use in integrating virtual content with real world content is discussed in greater detail in Haddick et al., U.S. Patent Application Publication No. 2012/0212488, published Aug. 23, 2012; Ota et al., U.S. Patent Application Publication No. 2013/0088516, published Apr. 11, 2013; Ota et al., U.S. Patent Application Publication No. 2013/0257908, published Oct. 3, 2013, which are hereby incorporate by reference in their entireties.

Furthermore, in some embodiments, the media guidance application may determine an acceptable variance in the position and/or angle at which a user optical device is directed for which virtual content may still be presented. For example, although virtual content may be associated with a particular position, and the media guidance application may only generate a display of the content if the user optical device is directed at that position, the media guidance application may also generate a display of the content if the user optical device is directed at an acceptable variance from that position. For example, the media guidance application may not require a user to direct the use optical device exactly at a particular position in order for content to be presented.

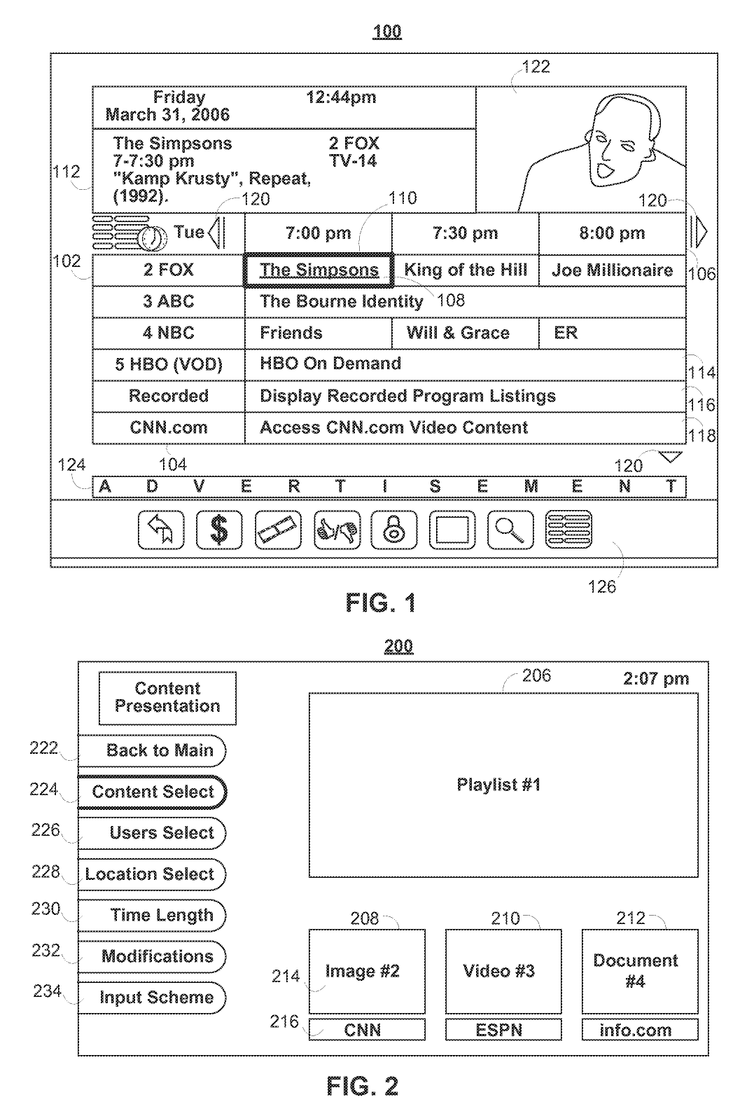

FIGS. 1-2 show illustrative display screens that may be used to provide media guidance data. In some embodiments, the display screens of FIGS. 1-2 may appear as content to one or more user optical devices. While the displays of FIGS. 1-2 are illustrated as full screen displays, they may also be fully or partially overlaid over physically existing objects (e.g., a portion of a wall, table, or any other physical structure). A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In some embodiments, such indications may communicated to the media guidance application by contacting a physically existing object associated with the content (e.g., the physically existing object to which the content is fixed).

In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria on one or more user optical devices. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes media assets 206, 208, 210, and 212. In some embodiments, display 200 may by shown as virtual content to a user operating an user optical device. For example, display 200 may be fixed to a particular position and a user operating an user optical device may perceive display 200 when the user directs the user optical device at the position.

In addition to media assets 206, 208, 210, and 212, display 200 may provide graphical images including cover art, still images from the content, video clip previews, live video from the content, or other types of content that indicate to a user the content being described by the media guidance data in display 200. Each of the graphical listings may also be accompanied by text to provide further information about the content associated with the listing. For example, media asset 208 may include more than one portion, including media portion 214 and text portion 216. Media portion 214 and/or text portion 216 may be selectable (e.g., via a user interaction at an object to which display 200 is fixed) to view content in full-screen or to view information related to the content displayed in media portion 214 (e.g., to view listings for the channel that the video is displayed on).

Media assets 206, 208, 210, and 212 in display 200 are of different sizes (i.e., media asset 206 is larger than media assets 208, 210, and 212), but if desired, all the media assets may be the same size. Media assets may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

Display 200 also includes selectable options 222 through 234 that are related to the presentation of virtual content. In some embodiments, display 200 may represent a set-up menu for hosting virtual content. For example, in some embodiments, display 200 may be reachable by navigating another menu (e.g., accessible by selecting selectable option 222). In display 200, selectable option 222 is currently selected. In response, the media guidance application has presented media assets 206, 208, 210, and 212. For example, in response to a user selection one or more of media assets 206, 208, 210, and 212 may be presented to a group of users as virtual content.

Display 200 also includes selectable option 226, which may be used to identify users that may be invited to view the virtual presentation. In some embodiments, only user optical devices that are determined to be associated with an identified user may receive an invitation to view the virtual presentation. If an invited user accepts the invitation, the media guidance application associated with the hosting user optical device transmits the instructions to present the virtual presentation of the content.

For example, the media guidance application may link a plurality of user optical devices so that only users associated with the linked user optical devices may perceive the content. In some embodiments, the media guidance application may receive user inputs (e.g., via selectable option 226) identifying each user (and/or user device) that should be able to perceive the content. In some embodiments, the media guidance application may automatically identify the users based on various criteria. For example, a first user may host the presentation of the content and automatically invite other users that share a geographic, demographic, familial, or social network relationship with the first user to have their respective user optical devices linked. In some embodiments, the criteria for inviting users to viewing the virtual presentation of the content may also be selected via selectable option 226.

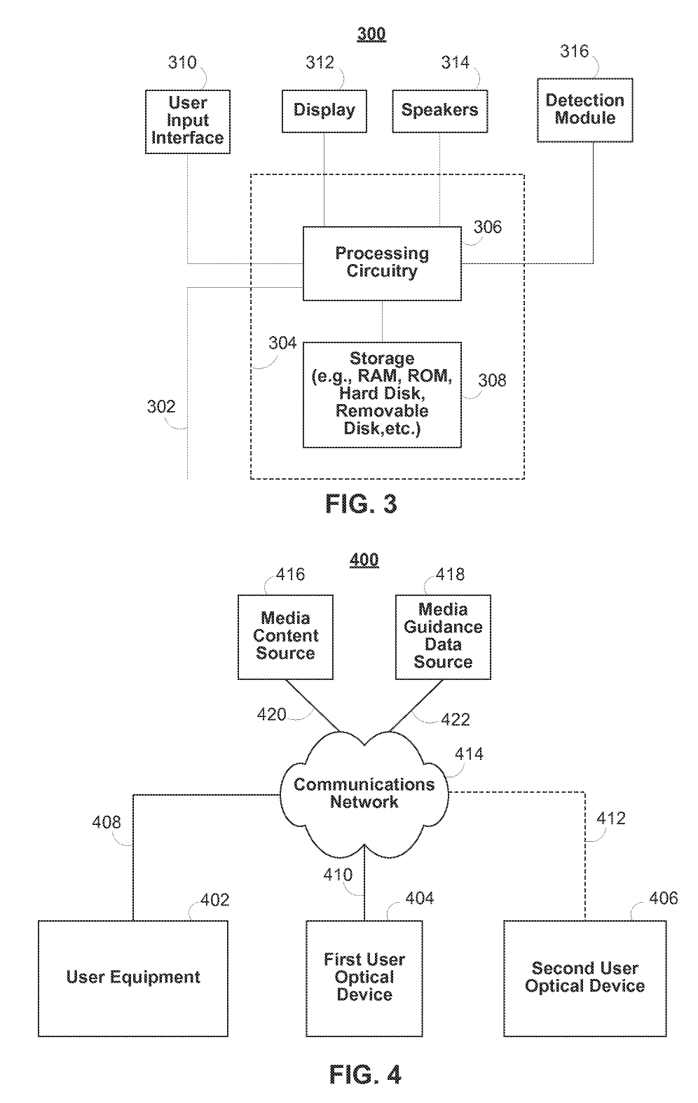

Display 200 also includes selectable option 228, which may be used by a user to select a location for the virtual presentation of the content. For example, the media guidance application may detect objects via object recognition techniques (e.g., as discussed below in relation to FIG. 3). The detected objects may then be selected by a user as object to which a virtual presentation of content may be fixed. For example, using selectable option 226, the media guidance application may receive a user input indicating one or more of a plurality of objects within the field of vision of the user for associating with virtual content.

For example, the media guidance application may match the coordinates defining bounds of the virtual content that is presented to the coordinates of the bounds of a real world object. Furthermore, the media guidance application may determine a position of the user and adjust the virtual presentation based on the position of the user (e.g., ensuing that the virtual presentation is facing towards, not away from the user). Accordingly, the virtual content is shown only when the object appears in the field of vision of the user.

In some embodiments, the media guidance application may also receive user selections related to the re-positioning of the virtual content. For example, in some embodiments, the virtual content may be fixed to a real world objects. Accordingly, the virtual content is shown only when the object appears in the field of vision of the user. In other embodiments, in response to a user request, the media guidance application may reposition the virtual content. For example, the virtual content may be re-positioned from an object not currently in the field of vision of the user to an object that is currently in the field of vision of the user. In some embodiments, the media guidance application may receive a manual selection from the user each time the user wishes to re-position virtual content. Alternatively, the media guidance application may automatically map the virtual content to new objects within the field of vision of a user as an object the virtual content is currently fixed to moves out of the field of vision of the user.

In some embodiments, the media guidance application may also receive user decisions as to how virtual content is played back. For example, if the virtual asset is a video, the video may play back even if the video is not fixed to an object within the field of vision of the user (e.g., the virtual content is not presented to a user). In some embodiments, the media guidance application may continue playback of the media asset even if the virtual content is not being perceived by the user. In such embodiments, speakers (e.g., speakers 314 (FIG. 3)) below may still transmit sound associated with the video.

Display 200 also includes selectable option 230. The media guidance application may receive user inputs indicating a length of time that content should be presented. For example, using selectable option 230, the media guidance application may determine that a virtual presentation should be presented for ten minutes, one-hour, etc.

Display 200 also includes selectable option 212. Selectable option 232 indicates whether or not a virtual presentation of content may be modified by other users that are associated with user optical devices that are linked to the virtual presentation, and selectable option 234 indicates the type of user interactions that will cause the content to be modified. For example, in some embodiments, the media guidance application may allow users to modify the presented content. For example, if the media guidance application presents content that is fixed to a particular real world object, the media guidance application may monitor the actions of users relative to the real world object. If the users contact the real world object and/or performs other actions within the vicinity of the real world object, the media guidance application may determine whether or not the contact and/or actions cause a corresponding change to the present content. If so, the media guidance application may update the content based on the modifications associated with the contact and/or actions.

Users may access content and the media guidance application (and its display screens described above and below) from one or more of their user equipment devices. For example, user may access content and the media guidance application from one or more user optical devices. FIG. 3 shows a generalized embodiment of illustrative user equipment device 300, which may, in some embodiments constitute an user optical device. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces.

In some embodiments, use input interface may be incorporated into user equipment device 300 or may be incorporated into another device accessible by user equipment device 300. For example, if user equipment device 300 is an user optical device, surface space limitation may prevent user input interface from recognizing one or more input types. In such case, user input interface 310 may be implemented on a separate device that is accessible to control circuitry 304 (FIG. 3)).

Display 312 may be provided as heads-up display for user equipment device 300. In some embodiments, if user equipment device 300 is an user optical device configured as headwear, display 312 may constitute a lens or similar feature of the headwear. In some embodiments, display 312 may be one or more of a monitor, a television, a liquid crystal display (LCD) for a mobile device, or any other suitable equipment for displaying visual images generated by the media guidance application while also allowing a user to see physically existing objects within his/her field of vision. In some embodiments, display 312 may be HDTV-capable. In some embodiments, display 312 may be a include 3D display properties, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

User equipment device 300 may also incorporate or be accessible to detection module 316. Detection module 316 may further include various components (e.g., a video detection component, an audio detection component, object recognition component, etc.). In some embodiments, detection module 316 may include components that are specialized to generate particular information (e.g., determine the coordinates associated with a physically existing object for use in present content perceived by a user to be fixed to the physically existing object, determine whether or not a user is interacting with a physically existing object in order to modify the content, etc.).

In some embodiments, detection module 316 may include a content recognition component. The content recognition component may use object recognition techniques such as edge detection, pattern recognition, including, but not limited to, self-learning systems (e.g., neural networks), optical character recognition, on-line character recognition (including but not limited to, dynamic character recognition, real-time character recognition, intelligent character recognition), and/or any other suitable technique or method to identify objects in the field of vision of the user and/or determine the coordinates of those objects.

In some embodiments, detection module 316 may also incorporate or have access to a global positioning module. Using the global positioning module, detection module 316 may define the coordinates of a detected object relative to the Earth. Based on this information, the media guidance application may determine the coordinates that virtual content should appear to be overlaid on in the field of vision of the user. For example, the media application may receive data in the form of a video from detection module 316. The video may correspond to the direction that a user optical device is currently pointed. Furthermore, the video may cover the entire field of vision of the user. The video may include a series of frames. For each frame of the video, the media application may use a content recognition module or algorithm to determine the real world objects in the frame. Detection module 316 may also determine the bounds of each detected object and describe those bounds in terms of global positioning coordinates retrieved from the global positioning module. The detected objects and the coordinates for those objects may then be sent to control circuitry 304 (FIG. 3)).

The media guidance application may then match the coordinates defining the bounds of the virtual content that is presented to the coordinates of the bounds of the object. Furthermore, the media guidance application may determine a position of the user and adjust the virtual presentation based on the position of the user (e.g., ensuing that the virtual presentation is facing towards, not away from the user). Accordingly, the virtual content is shown only when the object appears in the field of vision of the user.

In some embodiments, detection module 316 may include an eye contact detection component, which determines or receives a location upon which one or both of a user's eyes are focused. The location upon which a user's eyes are focused is referred to herein as the user's “gaze point.” In some embodiments, the eye contact detection component may monitor one or both eyes of a user of user equipment 300 to identify a gaze point on at a position on display 312 for the user. The eye contact detection component may additionally or alternatively determine whether one or both eyes of the user are focused on a position on display 312 associated with virtual content (e.g., indicating that a user is focusing on virtual content) or focused on a location that is not associated with virtual content. In some embodiments, the eye contact detection component includes one or more sensors that transmit data to processing circuitry 306, which determines a user's gaze point. The eye contact detection component may be integrated with other elements of user equipment device 300, or the eye contact detection component, or any other component of detection module 316, and may be a separate device or system in communication with user equipment device 300.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user equipment 402, first user optical device 404, second user optical device 406, or any other type of user equipment suitable for presenting/accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment 402 device and first user optical device 404 or second user optical device 406 utilizing at least some of the system features described above in connection with FIG. 3 may not be classified solely as user equipment or user optical devices. For example, in some embodiments, user equipment or user optical devices may act like television equipment (e.g., include a tuner allowing for access to television programming) and user computer equipment (e.g., be Internet-enabled allowing for access to Internet content). The media guidance application may have the same layout on various different types of user equipment or may be tailored to the display capabilities of the user equipment. For example, on user computer equipment, the guidance application may be provided as a web site accessed by a web browser. In another example, the guidance application may be scaled down for wireless user communications devices (e.g., smartphones).

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user equipment 402, first user optical device 404, second user optical device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user equipment 402, first user optical device 404, and second user optical device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment 402, first user optical device 404, and second user optical device 406 are shown as through communications network 414, in some embodiments, sources 416 and 418 may communicate directly with user equipment 402, first user optical device 404, and second user optical device 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment 402, first user optical device 404, and second user optical device 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment 402, first user optical device 404, and second user optical device 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user equipment 402, first user optical device 404, and second user optical device 406 may access the media guidance application to navigate among and locate desirable content. Users may also access the media guidance application outside of the home using first user optical device 404, and second user optical device 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user equipment 402, first user optical device 404, and second user optical device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user equipment 402, first user optical device 404, or second user optical device 406. Alternatively, the user can first transfer the content to a user equipment device, such as user equipment 402, first user optical device 404, or second user optical device 406. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

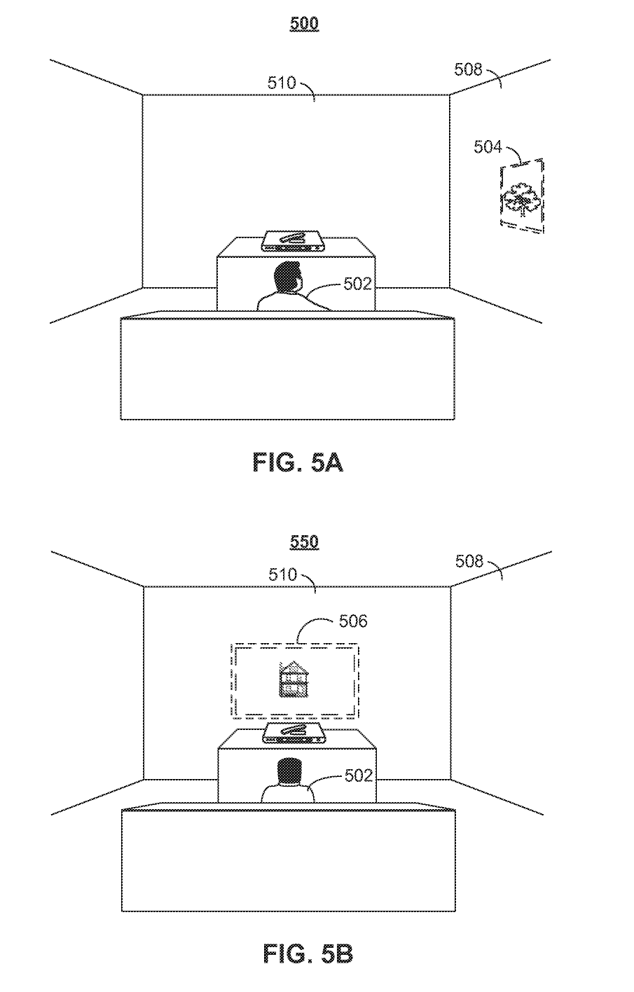

FIGS. 5A and 5B are illustrative examples of a viewing area for user in presenting content using user optical devices. It should be noted that discussion related to FIGS. 5A and 5B relate to the perceptions of virtual content 504 and 506 as they would appear to user 502 even though FIGS. 5A and 5B are illustrated from a perspective behind user 502 (as opposed to a first-person perspective). For example, in some embodiments a media guidance application (e.g., implemented on first user optical device 404 (FIG. 4)) may only transmit instructions for simultaneously presenting content (e.g., to second user optical device 406 (FIG. 4)) in response to determining that a device receiving an instruction is within a viewing area.

In some embodiments, the viewing area may be defined as a geographical location (e.g., a room of a household), an area accessible by a particular network (e.g., a household Wi-Fi connection), an area associated from which a certain object (e.g., an object to which content has been fixed) is viewable, etc. For example, by limiting the transmission of instructions to user optical devices within a particular viewing area, the media guidance application ensures that a user associated with an user optical device can perceive an object to which content is fixed (as well as the content itself) when the user optical device is directed at a particular position.

FIG. 5A illustrates viewing area 500. In viewing area 500, user 502 is currently operating an user optical device. Accordingly, user 502 may perceive content presented by the media guidance application when user 502 directs the user optical device at particular positions. In FIG. 5A, user 502 is currently directing an user optical device (i.e., user 502 is currently looking) at wall 508. The media guidance application implemented on the user optical device worn by user 502 is currently presenting content (e.g., virtual content 504) at a position corresponding to wall 508. Accordingly, while the user optical device worn by user 502 is directed at wall 508, the media guidance application presents virtual content 504.

In viewing area 500, virtual content 504 appears fixed to wall 508. For example, the media guidance application has selected a physically existing object (e.g., wall 508) to upon which to overlay virtual content 504. It should be noted that other users (not shown) in viewing area 500 may not perceive virtual content 504 on wall 508 unless the other users are operating user optical devices that have received instructions from a media guidance application implemented on the user optical device worn by user 502 to present virtual content 504.

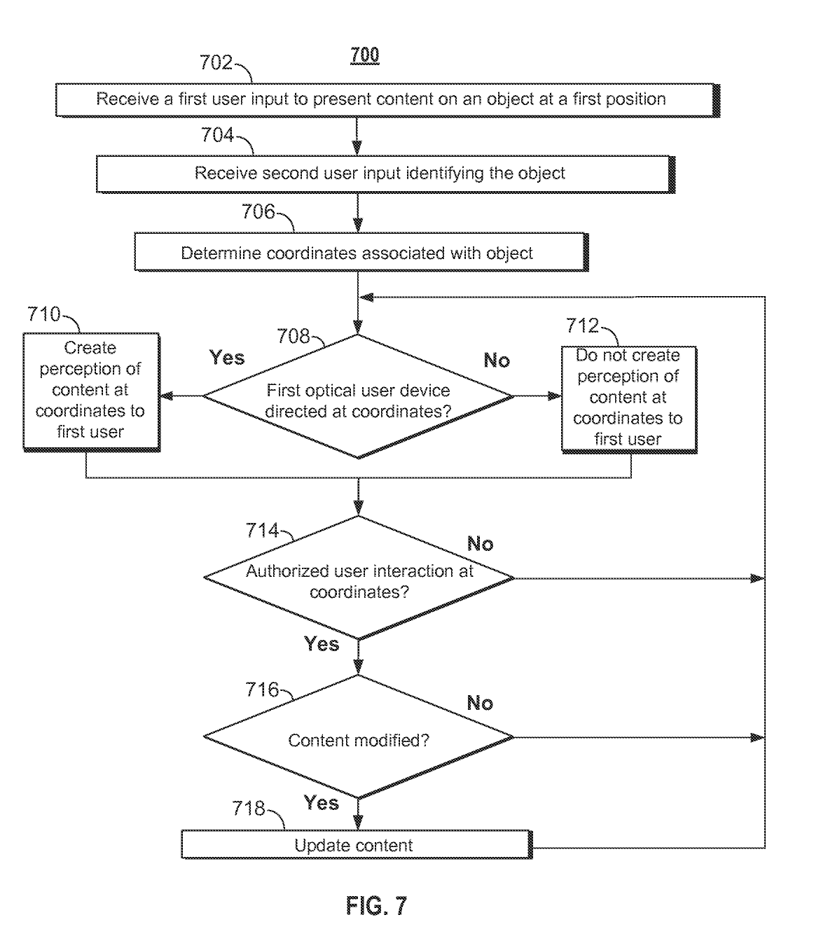

In some embodiments, as discussed below in relation to FIG. 7, the media guidance application may determine coordinates associated with wall 508. For example, in order to present content that appears to user 502 as fixed to wall 508, the media guidance application must first detect wall 508 and determine coordinates associated with wall 508 (e.g., via detection module 316 (FIG. 3)). After determining the coordinates associated with wall 508, the media guidance application may then present virtual content 504 as an overlay on wall 508.

FIG. 5B illustrates viewing area 550. In viewing area 550, user 502 is still operating an user optical device. Accordingly, user 502 may perceive content presented by the media guidance application when user 502 directs the user optical device at particular positions. In FIG. 5B, user 502 is currently directing an user optical device (i.e., user 502 is currently looking) at wall 510. The media guidance application implemented on the user optical device worn by user 502 is currently presenting content (e.g., virtual content 506) at a position corresponding to wall 508. Accordingly, while the user optical device worn by user 502 is directed at wall 510, the media guidance application presents virtual content 506. Furthermore, as the user optical device worn by user 502 is no longer directed at wall 508, the media guidance application is no longer presenting virtual content 504. It should be noted that virtual content 504 and virtual content 506 may each correspond to a different set of virtual content, in which each associated with a different real world position.

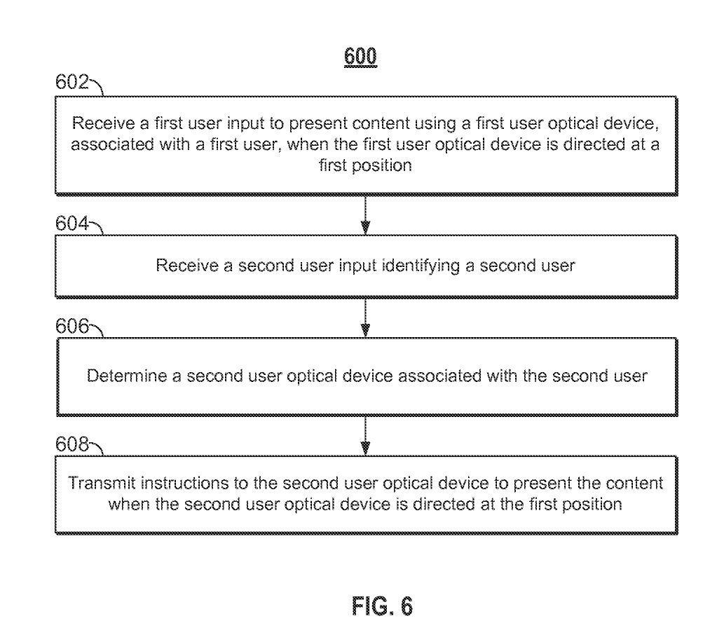

FIG. 6 is a flowchart of illustrative steps for presenting content to multiple users. It should be noted that process 600 or any step thereof could be performed on, or provided by, any of the devices shown in FIGS. 3-4. For example, process 600 may be executed by control circuitry 304 (FIG. 3) as instructed by a media guidance application implemented on user equipment 402, first user optical device 404, and/or second user optical devices 406 (FIG. 4) in order to present content to multiple user. In addition, one or more steps of process 600 may be incorporated into or combined with one or more steps of any other process or embodiment (e.g., process 700 (FIG. 7)).

At step 602, the media guidance application receives a first user input to present content using a first user optical device, associated with a first user, when the first user optical device is directed at a first position. For example, the media guidance application may receive a user input via an interface (e.g., user input interface 310 (FIG. 3)) associated with the first user optical device (e.g., first user optical device 404 (FIG. 3)), via an interface associated with another device (e.g., user equipment 402 (FIG. 4)), and/or via an on-screen menu (e.g., display 200 (FIG. 2)) initiating the presentation of virtual content.

At step 604, the media guidance application receives a second user input identifying a second user. For example, the media guidance application may receive a user input via an interface (e.g., user input interface 310 (FIG. 3)) associated with the first user optical device (e.g., first user optical device 404 (FIG. 3)), via an interface associated with another device (e.g., user equipment 402 (FIG. 4)), and/or via an on-screen menu (e.g., display 200 (FIG. 2)) identifying users that should be invited to view the virtual presentation of content.

At step 606, the media guidance application determines a second user optical device associated with the second user. In some embodiments, only user optical devices (e.g., first user optical device 404 and/or second user optical device 406 (FIG. 4)) that are determined (e.g., via control circuitry 304 (FIG. 3)) to be associated with an identified user (e.g., user 502 (FIG. 3)) may receive an invitation to view the virtual presentation.

For example, the media guidance application may link (e.g., via control circuitry 304 (FIG. 3)) a plurality of user optical devices (e.g., first user optical device 404 and second user optical device 406 (FIG. 4)) so that only users associated with the linked user optical devices may perceive the content. In some embodiments, the media guidance application may receive user inputs (e.g., via selectable option 226) identifying each user that should be able to perceive the content. In some embodiments, the media guidance application may automatically identify (e.g., via control circuitry 304 (FIG. 3)) the users based on various criteria. For example, a first user may host the presentation of the content and automatically invite other users that share a geographic, demographic, familial, or social network relationship with the first user (e.g., as determine by control circuitry 304 (FIG. 3)) to have their respective user optical devices linked.

For example, the media guidance application may retrieve (e.g., from a user profile stored locally at storage 308 (FIG. 3) or remotely at any location accessible via communications network 414 (FIG. 4)) a list of one or more user optical devices associated with an identified user. In some embodiments, the media guidance application may facilitate the sharing of identification information between user optical devices that identifies a user currently operating each respective user optical device. In some embodiments, the media guidance application may retrieve an identifier (e.g., a serial number) associated with an user optical device. The media guidance application may then cross-reference that identifier with a database (e.g., located at any location accessible via communications network 414 (FIG. 4)) to determine a user associated with the identifier. Based on the cross-reference, the media guidance application may match an user optical device to a particular user.

It should be noted that in some embodiments, the identify of the user and the association of a user with an user optical device may be so intertwined (e.g., a user identity may be synonymous with the identify of an user optical device) that steps 604 and 606 may be combined.

At step 608, the media guidance application transmits instructions to the second user optical device to present the content when the second user optical device is directed at the first position. For example, if an invited user accepts the invitation to view the virtual presentation of content (e.g., as determined via control circuitry 304 (FIG. 3) based on a response received from the second user optical device), the media guidance application associated with the hosting user optical device transmits (e.g., via I/O path 302 (FIG. 3)) the instructions to present the virtual presentation of the content.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one of more of the steps in FIG. 6.

FIG. 7 is a flowchart of illustrative steps for presenting content subject to user modifications. It should be noted that process 700 or any step thereof could be performed on, or provided by, any of the devices shown in FIGS. 3-4. For example, process 700 may be executed by control circuitry 304 (FIG. 3) as instructed by a media guidance application implemented on user equipment 402, first user optical device 404, and/or second user optical devices 406 (FIG. 4) in order to present content subject to user modifications. In addition, one or more steps of process 700 may be incorporated into or combined with one or more steps of any other process or embodiment (e.g., process 600 (FIG. 6)).

At step 702, the media guidance application receives a first user input to present content on an object at a first position. In some embodiments, step 702 may correspond to step 602 (FIG. 6)). For example, as described above, the media guidance application may receive a user input via an interface (e.g., user input interface 310 (FIG. 3)) associated with the first user optical device (e.g., first user optical device 404 (FIG. 3)), via an interface associated with another device (e.g., user equipment 402 (FIG. 4)), and/or via an on-screen menu (e.g., display 200 (FIG. 2)) initiating the presentation of virtual content.

At step 704, the media guidance application receives second user input identifying object. For example, the media guidance application may receive a user input via an interface (e.g., user input interface 310 (FIG. 3)) associated with the first user optical device (e.g., first user optical device 404 (FIG. 3)), via an interface associated with another device (e.g., user equipment 402 (FIG. 4)), and/or via an on-screen menu (e.g., display 200 (FIG. 2)) selecting a particular object to which the virtual presentation of content should be fixed.

At step 706, the media guidance application determines the coordinates associated with the object. For example, the media guidance application may receive information from a detection module (e.g., detection module 316 (FIG. 3)) that indicates objects with a field of vision of the user. The detection module (e.g., detection module 316 (FIG. 3)) may also determine the bounds of these objects. Based on this information, the media guidance application may determine (e.g., via control circuitry 304 (FIG. 3)) the coordinates that virtual content (e.g., virtual content 504 (FIG. 5)) should appear to be overlaid on in the field of vision of the user (e.g., user 502 (FIG. 5)).

At step 708, the media guidance application determines if the first user optical device is directed at the coordinates. For example, in some embodiments, the media guidance application may only present (e.g., on display 312 (FIG. 3)) the virtual content (e.g., virtual content 504 (FIG. 5)) when an user optical device (e.g., first user optical device 404 (FIG. 4)) is directed at a position (e.g., wall 508 (FIG. 5)) associated with the content. For example, if content is associated with a particular position (or a particular object at the position), the content (as perceived by the user) will not move (relative to that object) if the user looks away from the position.

If the first user optical device is directed at the coordinates, the media guidance application proceeds to step 710 and creates a perception of the content at the coordinates to the first user. For example, if the first user optical device is directed at the coordinates, the media guidance application creates (e.g., via control circuitry 304 (FIG. 3)) a perception of the content (e.g., virtual content 504 (FIG. 5)) at the coordinates (e.g., wall 508 (FIG. 5)) to the first user (e.g., user 502 (FIG. 5)) by mapping the bounds of the content to the coordinates of the object. For example, if the media guidance application determines (e.g., via detection module 316 (FIG. 3)) that a particular object is defined by several x, y, and z coordinates, the media guidance application may make the bounds of the content equal to the x, y, and z coordinates of the object such that the content appears fixed to the object. If the first user optical device is not directed at the coordinates, the media guidance application proceeds to step 712 and does not create a perception of the content at the coordinates to the first user.

At step 714, the media guidance application determines if authorized user interactions are detected at coordinates. For example, the media guidance application may allow users to modified content in a virtual presentation. For example, the media guidance application may receive a selection (e.g., via user input interface 310 (FIG. 3)) from the user optical device (e.g., first user optical device 404 (FIG. 4)) hosting the virtual presentation of content enabling users to interact with the virtual content or the real world object (e.g., wall 504 (FIG. 5A)) that the content is fixed to in order to modify the content.

For example, if the media guidance application presents content that is fixed to a particular real world object, the media guidance application may monitor (e.g., via detection module 316 (FIG. 3)) the actions of users relative to the real world object. If the users contact the real world object and/or performs other actions within the vicinity of the real world object, the media guidance application may determine (e.g., via control circuitry 304 (FIG. 3)) whether or not the contact and/or actions cause a corresponding change to the present content. If so, the media guidance application may update the content based on the modifications associated with the contact and/or actions. In some embodiments, in addition to allowing users to modify content (e.g., in response to a user selection of selectable option 232 (FIG. 2)), the media guidance application may define the types of user interactions that cause modification to the content (e.g., in response to a user selection of selectable option 234 (FIG. 2)). For example, the media guidance application may determine that only certain types of inputs (e.g., swipes) will cause modifications to the content.

Furthermore, the media guidance application may also determine whether the user interaction detected was from an authorized user. For example, contact by a person that is not an identified user with a real world object to which content is fixed may not cause the content to be modified. Furthermore, the media guidance application may restrict (e.g., based on user selections relative to selectable option 226 (FIG. 2)) whether or not particular user may modify content. If the user interaction is from an authorized user and at the coordinates of the object to which the content is fixed (e.g., as determined by control circuitry 304 (FIG. 3)), the media guidance application proceeds to step 716. If not, the media guidance application returns to step 708.

At step 716, the media guidance application determines whether or not the content is modified. For example, the media guidance application determines (e.g., via control circuitry 304 (FIG. 3)) whether or not the detect user interaction resulted in a modification to the content. If not, the media guidance application returns to step 708. If so, the media guidance application proceeds to step 718.

At step 718, the media guidance application updates the content. In some embodiments, updating the content involves the media guidance application implemented on the user optical device (e.g., first user optical device 404 or second user optical device 406 (FIG. 4)) that detected the user interaction (e.g., via detection module 316 (FIG. 3)) transmitting (e.g., via communications network 414 (FIG. 4)) instructions to the other linked user optical devices (e.g., first user optical device 404 or second user optical device 406 (FIG. 4)) describing how the content should be updated. In response to these instructions, the other user optical device updated the content (e.g., as displayed on each user optical device respective display 312 (FIG. 3)) such that each user perceives the updated content.

For example, if the content relates to a media playlist and one user (e.g., user 502 (FIG. 5)) associated with a first user optical device (e.g., first user optical device 404 (FIG. 4)) adds a song to the media playlist. The first user optical device will detect (e.g., via detection module 316 (FIG. 3)) this modification and, along with modifying the content perceived by the first user accordingly, transmit instructions to the other linked user optical devices (e.g., second user optical device 406 (FIG. 4)) to also modify the content as perceived by their respective users accordingly.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one of more of the steps in FIG. 7.

FIG. 8 is an illustrative example of one component of a detection module (e.g., detection module 316 (FIG. 3)), which may be accessed by a media guidance application in accordance with some embodiments of the disclosure. FIG. 8 shows eye contact detection component 800, which may be used to identify the gaze point of a user of user equipment 300, in order to determine whether or not a user is focusing on a particular position. For example, the location upon which a user's eyes are focused may determine whether or not the media guidance application generates a presentation of virtual content. For example, eye contact detection component 800 may determine whether one or both eyes of the user are focused on a position on a display (e.g., display 312 (FIG. 3)) associated with the media guidance application.

Eye contact detection component 800 includes processor 802, light source 804, and optical sensor 806. Light source 804 transmits light that reaches at least one eye of a user, and optical sensor 806 is directed at the user to sense reflected light. Optical sensor 806 transmits collected data to processor 802, and based on the data received from optical sensor 806, processor 802 determines a user's gaze point.

In some embodiments, eye contact detection component 800 is configured for determining a gaze point of a single user. In other embodiments, eye contact detection component 800 may determine gaze points for a plurality of users. Eye contact detection component 800 may identify multiple users of user devices (e.g., user equipment device 300 (FIG. 3)).

Processor 802 may be integrated with one or more light sources 804 and one or more optical sensors 806 in a single device. Additionally or alternatively, one or more light sources 804 and one or more optical sensors 806 may be housed separately from processor 802 and in wireless or wired communication with processor 802. One or more of processors 802, light sources 804, and optical sensors 806 may be integrated into a user device (e.g., user equipment device 300 (FIG. 3)).

Processor 802 may be similar to processing circuitry 306 (FIG. 3) described above. In some embodiments, processor 802 may be processing circuitry 306 (FIG. 3), with processing circuitry 306 in communication with light source 804 and optical sensor 806. In other embodiments, processor 802 may be separate from but optionally in communication with processing circuitry 306.

Light source 804 transmits light to one or both eyes of one or more users. Light source 804 may emit, for example, infrared (IR) light, near infrared light, or visible light. The light emitted by light source 804 may be collimated or non-collimated. The light is reflected in a user's eye, forming, for example, the reflection from the outer surface of the cornea (i.e. a first Purkinje image), the reflection from the inner surface of the cornea (i.e. a second Purkinje image), the reflection from the outer (anterior) surface of the lens (i.e. a third Purkinje image), and/or the reflection from the inner (posterior) surface of the lens (i.e. a fourth Purkinje image).

Optical sensor 806 collects visual information, such as an image or series of images, of one or both of one or more users' eyes. Optical sensor 806 transmits the collected image(s) to processor 802, which processes the received image(s) to identify a glint (i.e. corneal reflection) and/or other reflection in one or both eyes of one or more users. Processor 802 may also determine the location of the center of the pupil of one or both eyes of one or more users. For each eye, processor 802 may compare the location of the pupil to the location of the glint and/or other reflection to estimate the gaze point. Processor 802 may also store or obtain information describing the location of one or more light sources 804 and/or the location of one or more optical sensors 806 relative to a display (e.g., display 312 (FIG. 3)). Using this information, processor 802 may determine a user's gaze point on a display (e.g., display 312 (FIG. 3)), or processor 802 may determine whether or not a user's gaze point is at a particular position on the display (e.g., display 312 (FIG. 3)).

In some embodiments, eye contact detection component 800 performs best if the position of a user's head is fixed or relatively stable. In other embodiments, eye contact detection component 800 is configured to account for a user's head movement, which allows the user a more natural viewing experience than if the user's head were fixed in a particular position.

In some embodiments accounting for a user's head movement, eye contact detection component 800 includes two or more optical sensors 806. For example, two cameras may be arranged to form a stereo vision system for obtaining a 3D position of the user's eye or eyes; this allows processor 802 to compensate for head movement when determining the user's gaze point. The two or more optical sensors 806 may be part of a single unit or may be separate units. For example, a user device (e.g., user equipment device 300 (FIG. 3)) may include two cameras used as optical sensors 806, or eye contact detection component 800 in communication with the user device (e.g., user equipment device 300 (FIG. 3)) may include two optical sensors 806. In other embodiments, each of the user device (e.g., user equipment device 300 (FIG. 3)) and eye contact detection component 500 may include an optical sensor, and processor 802 receives image data from the optical sensor of the user device and the optical sensor of eye contact detection component 800. Processor 802 may receive data identifying the location of optical sensor 806 relative to a display (e.g., display 312 (FIG. 3)) and/or relative to each other and use this information when determining the gaze point.

In other embodiments accounting for a user's head movement, eye contact detection component 800 includes two or more light sources for generating multiple glints. For example, two light sources 804 may create glints at different locations of an eye; having information on the two glints allows the processor to determine a 3D position of the user's eye or eyes, allowing processor 802 to compensate for head movement. Processor 802 may also receive data identifying the location of light sources 804 relative to a display (e.g., display 312 (FIG. 3)) and/or relative to each other and use this information when determining the gaze point.

In some embodiments, other types of eye contact detection components that do not utilize a light source may be used. For example, optical sensor 806 and processor 802 may track other features of a user's eye, such as the retinal blood vessels or other features inside or on the surface of the user's eye, and follow these features as the eye rotates. Any other equipment or method for determining one or more users' gaze point(s) not discussed above may be used in addition to or instead of the above-described embodiments of eye contact detection component 800.

It should be noted that eye contact detection component 800 is but one type of component that may be incorporated into or accessible by detection module 316 (FIG. 3) or the media application. Other types of components, which may generate other types of data (e.g., video, audio, textual, etc.) are fully within the bounds of this disclosure.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted, the systems and/or methods described above may be applied to, or used in accordance with, other systems and/or methods.

1. A method of presenting information to groups, the method comprising:
receiving a first user input to present content using a first user optical device, associated with a first user, when the first user optical device is directed at a first position;
receiving a second user input identifying a second user;
determining a second user optical device associated with the second user; and
transmitting instructions to the second user optical device to present the content when the second user optical device is directed at the first position.

2. The method of claim 1, further comprising:
presenting the content on the first user optical device when the first user optical device is directed at the first position; and
not presenting the content on the first user optical device when the first user optical device is directed at a second position.

3. The method of claim 1, further comprising:
receiving a third user input, at the first user optical device, modifying the content; and
instructing the second user optical device to present the modified content when directed at the first position.

4. The method of claim 3, wherein the content appears fixed to an object at the first position.

5. The method of claim 4, wherein the third user input is received in response to a user interaction with the object at the first position.

6. The method of claim 4, wherein the modified content is a media playlist, and wherein the media playlist includes a media listing added by the third user input.

7. The method of claim 4, wherein the object at the first position is a portion of a wall, and wherein the content is only perceptible to users that have an user optical device, have received an instruction to present the content, and have the user optical device directed at the portion of the wall.

8. The method of claim 1, further comprising:
determining whether the second user is within a viewing area associated with the first position; and
not instructing the second user optical device to present the content when the second user optical device is directed at the first position in response to determining the second user is not within a viewing area associated with the first position.

9. The method of claim 1, wherein the second user is identified based on a geographic, demographic, familial, or social network relationship with the first user.

10. The method of claim 1, wherein the plurality of user optical devices are configured as headwear.

11. A system of presenting information to groups, the system comprising control circuitry that:
receives a first user input to present content using a first user optical device, associated with a first user, when the first user optical device is directed at a first position;
receives a second user input identifying a second user;
determines a second user optical device associated with the second user; and
transmits instructions to the second user optical device to present the content when the second user optical device is directed at the first position.

12. The system of claim 11, wherein the control circuitry:
presents the content on the first user optical device when the first user optical device is directed at the first position; and
does not present the content on the first user optical device when the first user optical device is directed at a second position.

13. The system of claim 11, wherein the control circuitry:
receives a third user input, at the first user optical device, modifying the content; and
instructs the second user optical device to present the modified content when directed at the first position.

14. The system of claim 13, wherein the content appears fixed to an object at the first position.

15. The system of claim 14, wherein the third user input is received in response to a user interaction with the object at the first position.

16. The system of claim 14, wherein the modified content is a media playlist, and wherein the media playlist includes a media listing added by the third user input.

17. The system of claim 14, wherein the object at the first position is a portion of a wall, and wherein the content is only perceptible to users that have an user optical device, have received an instruction to present the content, and have the user optical device directed at the portion of the wall.

18. The system of claim 11, wherein the control circuitry:
determines whether the second user is within a viewing area associated with the first position; and
does not instruct the second user optical device to present the content when the second user optical device is directed at the first position in response to determining the second user is not within a viewing area associated with the first position.

19. The system of claim 11, wherein the second user is identified based on a geographic, demographic, familial, or social network relationship with the first user.

20. The system of claim 11, wherein the plurality of user optical devices are configured as headwear.

21-50. (canceled)
